(19) United States
(12) Patent Application Publication
(10) Pub. No.: US 2025/0322984 A1
(43) Pub. Date: Oct. 16, 2025

(54) TRANSFORMER AND METHOD OF FORMING

(71) Applicant: GE Aviation Systems Limited, Gloucestershire (GB)

(72) Inventors: Ren Xie, Schenectady, NY (US); Cong LI, Clifton Park, NY (US); Frank J. Mueller, Glenville, NY (US); Xiaochuan Jia, Centerville, OH (US); David Dimitri Karipides, Casstown, OH (US); Michael Klausen, Niskayuna, NY (US)

(21) Appl. No.: 18/631,639

(22) Filed: Apr. 10, 2024

(51) Int. Cl. H01F 27/06; H01F 27/00; H01F 27/28; H01F 41/04; H01F 41/10

(52) U.S. Cl. CPC H01F 27/06; H01F 27/2804; H01F 27/2823; H01F 41/041; H01F 41/10; H01F 27/006; H01F 2027/065; H01F 2027/2814; H01F 2027/2833

(57) ABSTRACT

A transformer and method of forming is disclosed. A set of windings including a coaxial cable portion and a printed circuit board (PCB) trace portion are wound around a magnetic core. The coaxial cable portion defines a portion of the primary windings and a portion of the secondary windings. The PCB trace portion includes a set of first PCB traces and a set of second PCB traces to define another portion of the primary windings, and a set of third PCB traces and fourth PCB traces define another portion of the secondary windings. The set of third PCB traces and fourth PCB traces are electrically coupled by a set of conductive vias. The third PCB traces, fourth PCB traces and the set of conductive vias circumferentially surround at least a portion of the first PCB trace and a second PCB trace.

### TECHNICAL FIELD

The present disclosure relates generally to electrical inductors and more particularly to a transformer using co-axial cables and printed circuit board (PCB) technology.

### BACKGROUND

Electrical transformers are inductive devices typically consisting of a pair of wire coils or windings having a number of turns wrapped around a ferromagnetic core. The pair of coils include a primary winding through which electrical current is directed, and a secondary winding which is electrically isolated from the primary winding. A magnetic field generated by current flow in the primary winding inductively couples to the secondary winding, and variations in the magnetic field induce a current flow in the secondary winding. The ferromagnetic core provides a low reluctance path for the magnetic field. A magnitude of the induced current flow depends on a ratio of a number of wire turns in the primary winding to the number of wire turns in the secondary winding.

### BRIEF DESCRIPTION OF THE DRAWINGS

A full and enabling disclosure of the present description, including the best mode thereof, directed to one of ordinary skill in the art, is set forth in the specification, which refers to the appended FIGS., in which:

FIG. 1 depicts an isometric view of a conventional transformer.

FIG. 2 depicts a perspective view of a conventional coaxial cable.

FIG. 3 depicts a transformer in accordance with various aspects described herein.

FIG. 4 depicts a schematic block diagram of the transformer of FIG. 3 in accordance with various aspects described herein.

FIG. 5 depicts a schematic block diagram another exemplary transformer in accordance with various aspects described herein.

FIG. 6 depicts a schematic diagram of a portion of the transformer of FIG. 5 in accordance with various aspects described herein.

FIG. 7 depicts a flow diagram of a method of forming a transformer in accordance with various aspects described herein.

### DETAILED DESCRIPTION

The exemplary drawings are for purposes of illustration only and the dimensions, positions, order and relative sizes reflected in the drawings attached hereto can vary. Furthermore, the number of, and placement of, the various components depicted in the Figures are also non-limiting examples of aspects associated with the disclosure. For example, while various components have been illustrated with relative position of etc., aspects of the disclosure are not so limited, and the components are not so limited based on their schematic depictions.

Aspects of the disclosure can be implemented in any environment, apparatus, or method for an electrical filter regardless of the function performed by the apparatus or method.

As used herein, the term “set” or a “set” of elements can be any number of elements, including only one.

As used herein, the term “upstream” refers to a direction that is opposite the current flow direction, and the term “downstream” refers to a direction that is in the same direction as the current flow. Accordingly, an “upstream” end of an element opposes a “downstream” end of the element.

Additionally, while terms such as “voltage”, “current”, and “power” can be used herein, it will be evident to one skilled in the art that these terms can be interrelated when describing aspects of the electrical circuit, or circuit operations.

Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. In non-limiting examples, connections or disconnections can be selectively configured to provide, enable, disable, or the like, an electrical connection between respective elements. Additionally, as used herein, “electrical connection” or “electrically coupled” can include a wired or wireless connection. The exemplary drawings are for purposes of illustration only and the dimensions, positions, order and relative sizes reflected in the drawings attached hereto can vary.

As used herein, the term “conductivity” refers to a property of a material that allows a flow of charge or electric current therethrough. Also as used herein, the term “electrical conductor” or “conductive element” refers to a material or structure that exhibits a relatively high electrical conductivity (for example, greater than about 10-7 siemens per meter (S/m)). Unless stated otherwise, as used herein, the terms “conductive”, “conductor”, “conductivity” and the like refer to electrical properties of a material or structure. For example, the term “conductor” refers to an electrical conductor.

As used herein, the term “insulative” refers to a property of a material that resists a flow of charge or electric current therethrough Also as used herein, the term “insulator” or “insulation” refers to a material that exhibits a low electrical conductivity (for example, less than about 10-8 siemens per meter (S/m)). Unless stated otherwise, as used herein, the term “insulative” refers to electrical insulation, and the term “insulator” refers to an electrical insulator.

As used herein, the term “inductance” is a relative measure of the tendency of an electrically conductive material to oppose a change in the electric current flowing through it. Inductance can be expressed as a ratio of a voltage to the rate of change of current. In the International System of Units (SI), the unit of inductance is the henry (H).

As used herein, the term “cable” refers to an electrical transmission line or conductor operative to conduct electrical current in a contained manner between discrete devices, electrical components, or other conductors (e.g., PCB traces) within an electrical circuit or component. As used herein, the term “coaxial cable” refers to a conductive cable having an inner conductor circumferentially surrounded by a concentric outer conductor or conductive shield, with the inner conductor and outer conductor being separated by a dielectric or insulating material. Non-limiting examples of cables include wires, coaxial cables, busbars, or combinations thereof. As used herein, the terms “cable”, “coaxial cable” are not intended to be so broadly construed as to include PCB traces.

As used herein, the terms “traces” or “printed circuit board traces”, “PCB traces”, and the like refer to a planar conductive line or conductor integrally defined on a layer of a PCB. As used herein, the terms “traces” and “PCB traces” are not intended to be so broadly construed as to include be a cable or wire.

As used herein, the term “via” or “conductive via” refers to an electrically conductive path defined between different layers of a PCB. For example, a via can be arranged as an aperture or hole defined through the PCB layers and crosses two or more adjacent layers. The via can be covered internally with a conductive material such as copper (e.g., by galvanic process, riveting, or by inserting a small tube of conductive material), to form an electrical path in the insulating material that separates the PCB layers. As used herein, vias can include “through hole vias (e.g., that pass through the layers of the PCB, including the two opposing outer surfaces of the PCB), buried vias (e.g., that extend entirely inside the PCB without connections to the two opposing outer surface of the PCB), or blind vias (e.g., that extend from one outer surface of the PCB through one or more internal layers, without extending to the opposing outer surface of the PCB).

Conventional inductors are passive electrical components that store electrical energy in a magnetic field when an electric current flows through it. An inductor typically includes an insulated wire wound into a coil or winding. When the current flowing through the coil changes direction (e.g., an AC current), the time-varying magnetic field induces an electromotive force (emf) or voltage in the conductor, as described by Faraday's law of induction. An inductor is characterized by an inductance value. For example, conventional inductors have inductance values that commonly range from 1 μH (10-6 H) to 20 H. Typically, inductors have a magnetic core (e.g., a ferrite core) inside the coil, which serves to increase the magnetic field and thus the inductance.

When an AC voltage is applied across an inductor (e.g., a primary winding) a self-induced emf (e.g., a voltage) is generated as a result of the changing magnetic field around the winding turns. When the emf is induced into an adjacent winding (e.g., a secondary winding) disposed within the same magnetic field, the emf is said to be induced by mutual induction. Typically, “mutual inductance” refers to an electrical parameter between two magnetically coupled windings (e.g., a first winding and a second winding linked by a common magnetic flux) and defines a ratio of a time-varying magnetic flux created by the first winding being induced into the second winding.

Inductors that that store energy and transfer energy between windings are sometimes referred to as transformers or coupled inductors. Unless otherwise indicated, in this disclosure the term “transformer” can include coupled inductors.

Conventional transformers typically include two separate coils or sets of windings (e.g., inductors). The two separate coils often have different numbers of individual “turns” of respective insulated conductors wound around the same ferromagnetic core to have a magnetic coupling between them. Typically, transformers have a non-gapped ferromagnetic core, while coupled inductors employ a gapped core. The two coils are commonly referred to as a primary winding and a secondary winding, Typically, the primary winding is energized by a source, and the secondary winding is connected to a load.

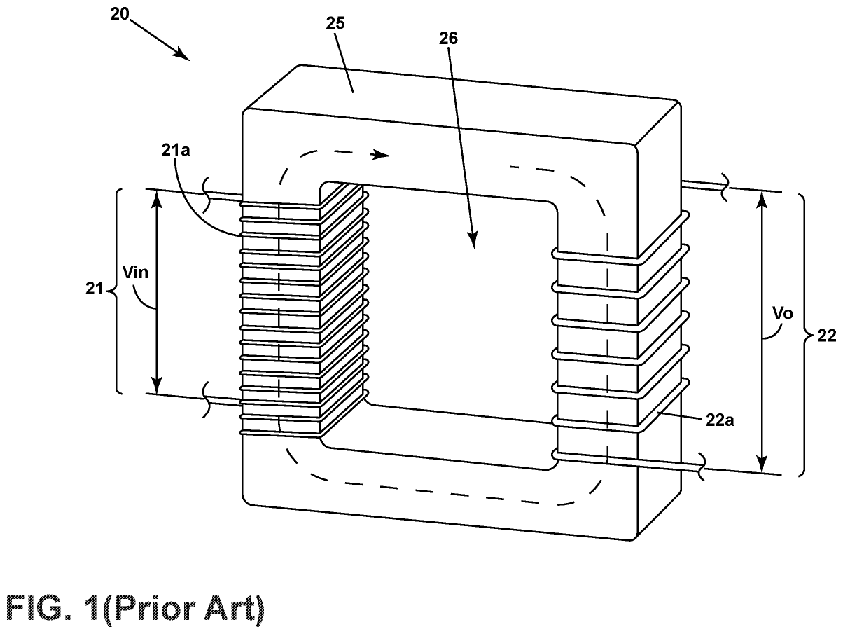

For example, FIG. 1 depicts an isometric view of a conventional transformer 20. The transformer includes a primary winding 21, a secondary winding 22, and an annular magnetic core 25 defining a bore 26. A first set of wire turns (primary winding turns 21a) are typically wound around a first side of the magnetic core 25 and through the bore 26 to collectively define the primary winding 21. A second set of wire turns (secondary winding turns 22a) are typically wound around an opposing second side of the magnetic core 25 and through the bore 26 to collectively define the secondary winding 22.

When an input voltage Vin is applied across the primary winding 21 an output voltage Vo is induced across the secondary winding 22. An efficiency of the mutual inductance, or magnetic coupling by which power is transferred from the primary winding 21 to the secondary winding 22 of a transformer 20, can be quantized as a “coefficient of coupling” of the transformer. Generally, the coefficient of coupling can be defined as a ratio of the number of magnetic flux lines common between two windings to the number of magnetic flux lines in a winding. The better the primary and secondary windings 21, 22 are magnetically coupled, the more efficient the electromagnetic induction between them. If the primary and secondary windings 21, 22 are perfectly magnetically coupled (e.g., all magnetic flux generated by the primary winding 21 penetrates the coil of the secondary winding 22), the coefficient of coupling is equal to 1. If there is the primary and secondary windings 21, 22 are un-coupled (e.g., the primary and secondary windings 21, 22 are perfectly shielded from each other) the coefficient of coupling is equal to 0. The coefficient of coupling can depend on the structural design of the transformer 20. For example, an important factor affecting the coefficient of coupling is the position of the primary and secondary winding 21, 22 with respect to the other. For example, if the primary winding 21 and secondary winding 22 are wound over one another and each line of flux from the primary winding 21 cuts a line of flux from the secondary winding 22, then the coupling coefficient is equal to 1. If any flux is lost, then the coefficient of coupling is less than 1. Imperfect magnetic coupling between the primary and secondary winding 21, 22 (e.g., less than all magnetic flux generated by the primary winding 21 penetrates the coil of the secondary winding 22), results in reduction of the voltage induced in the secondary winding 22. The imperfect coupling behaves as a self-inductance in series with the primary winding 21 or secondary winding 22 respective ohmic resistance and is referred to a “leakage inductance”. The leakage inductance is due to magnetic flux not linking with the turns of each imperfectly-coupled set of windings. The coefficient of coupling of typical transformers ranges from 0.950 to 0.990.

In many conventional transformers, the number of primary winding turns 21a in the primary winding 21 is different than the number of secondary winding turns 22a in the secondary winding 22. This difference in the number of primary and secondary winding turns 21a, 22a is commonly referred to as a turn ratio of the transformer 20. Typically, the turn ratio is defined as the ratio of a number of primary winding turns 21a in the primary winding 21 to a number of secondary winding turns 22a in the secondary winding 22. This turn ratio can be indicative of a ratio of the input voltage Vin applied across the primary winding 21 to the output voltage Vo induced across the secondary winding 22. The turn ratio is typically expressed as “Np:Ns” where, Np is equal to the number of primary winding turns 21a, and Ns is equal to the number of secondary winding turns 22a.

Transformers 20 having greater number of secondary winding turns 22a than primary winding turns 21a are referred to as step-up transformers. A step-up transformer 20 has a higher secondary or output voltage Vo than the primary or input voltage Vin. Transformers 20 having a greater number of primary winding turns 21a than secondary winding turns 22a are referred to as step-down transformers. A step-down transformer has a lower output voltage Vo than its input voltage Vin.

While conventional transformers 20 often use conventional insulated wires or cables to form the primary and secondary winding turns 21a, 22a, such transformers 20 can exhibit undesirably high leakage inductances due to the inherent gap between the discrete insulated wires forming the primary winding turns 21a of the primary winding 21 and those forming the secondary winding turns 22a of the secondary winding 22. One known technique to reduce this inherent gap is to use a conventional co-axial cable to form the primary winding turns 21a and secondary winding turns 22a. For example, some known transformers 20 have a coaxial cable (with the inner conductor arranged as the primary winding 21, and the outer conductor as the secondary winding 22) wound around a bobbin (not shown) and circumscribed by a toroidal magnetic core (not shown). However, such transformers 20 can have limited applicability because the turn ratio of these coaxial cable transformers is then necessarily limited to 1 to 1.

It would be desirable to provide a transformer having an improved coupling coefficient, (e.g., greater than 0.990) or reduced leakage inductance over conventional transformers while also enabling a turns ratio not limited to 1 to 1.

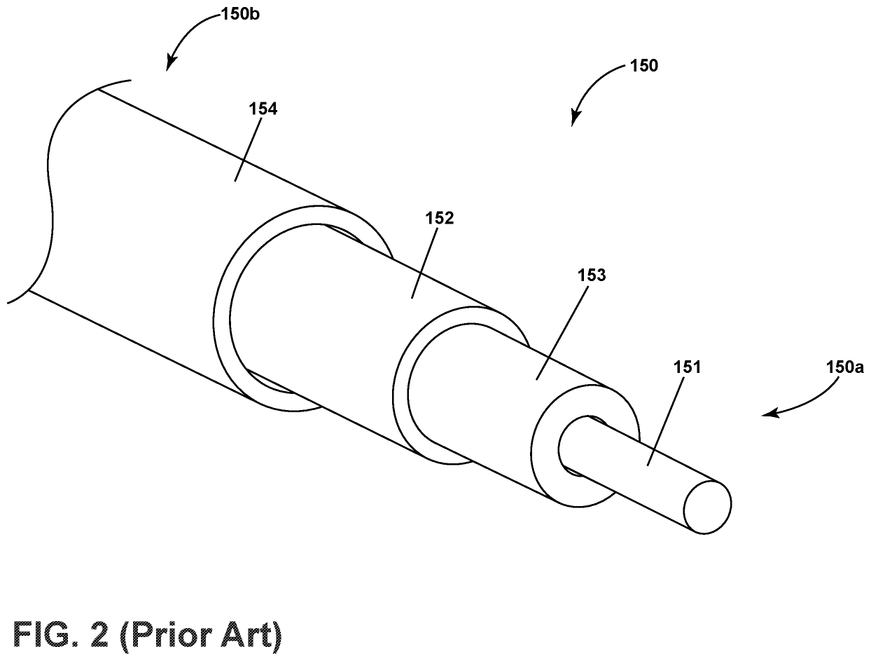

A conventional coaxial cable 150 is illustrated in FIG. 2. The coaxial cable 150 having a first end 150a and a diametric opposing second end 150b. The coaxial cable 150 can include an elongate central first conductive element 151 (e.g., a copper wire), or primary conductor, circumferentially surrounded by a first electrically insulative layer 153. The first electrically insulative layer 153 can be circumferentially surrounded by an elongate, generally tubular second conductive element 152. In some instances, the second conductive element 152 can be a sheath, shield, woven braid, or the like. In non-limiting aspects, a second electrically insulative layer 154 circumferentially surrounds the second conductive element. The first conductive element 151 and the second conductive element 152 extend from the first end 150a to the second end 150b of the coaxial cable 150. It will be appreciated that FIG. 2 depicts the coaxial cable 150 with a respective portion of the first electrically insulative layer 153, the second conductive element 152, and the second electrically insulative layer 154 at the first end 150a omitted for clarity.

While FIG. 2 depicts, for ease of description and understanding, the first conductive element 151 as having a generally circular cross section, in various instances, the first conductive element 151 can have any desired cross section including for example, oval, rectangular, and polygonal, without departing from the scope of the disclosure. Additionally, while FIG. 2 depicts the first conductive element 151 as being a single conductor or strand, in other aspects, the first conductive element 151 can comprise any desired number of conductors (e.g., a stranded wire) without departing from the scope of the disclosure.

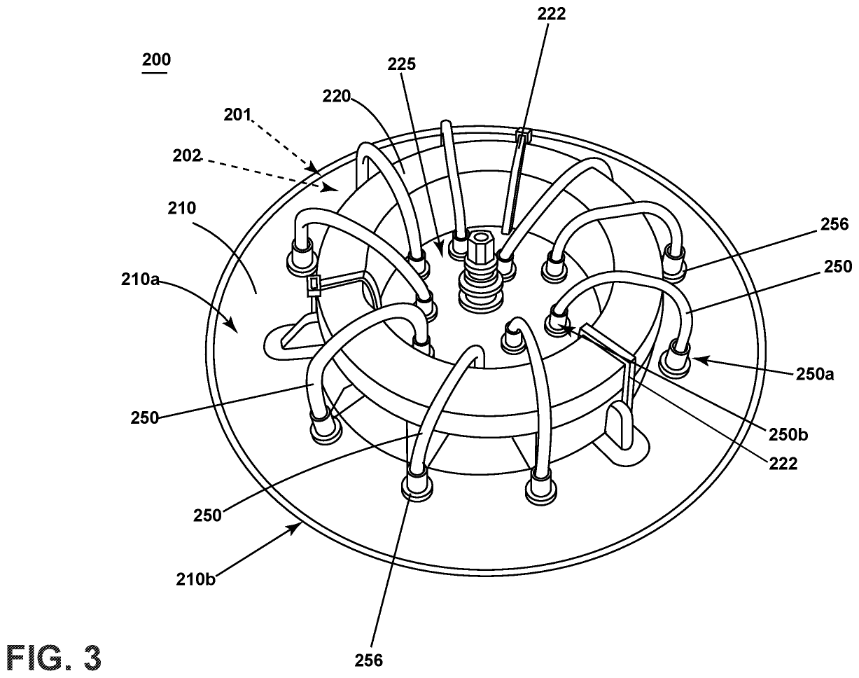

FIG. 3 is an isometric view of a non-limiting aspect of a transformer 200 having a primary winding 201 and a secondary winding 202. The transformer 200 includes a multi-layer PCB 210 having a first face 210a opposingly spaced from a second face 210b. An annular ferromagnetic core 220 is coupled to the first face 210a of the PCB 210. In non-limiting aspects, the ferromagnetic core 220 can be coupled to the first face 210a using straps 222. In other non-limiting aspects, the ferromagnetic core 220 can be coupled to the first face 210a using clamps, fasteners, adhesives, or combinations thereof. The ferromagnetic core 220 defines a bore 225 therethrough. While the exemplary aspect depicted in FIG. 3 depicts the transformer 200 having an annular ferromagnetic core 220, having no gaps, in other aspects, the ferromagnetic core 220 can include a gap (for example, to form a coupled inductor). A first set of coaxial cables 250 is arranged to extend through the bore and are coupled to the PCB 210 at a first end 250a and the second end 250b. In non-limiting aspects, the coaxial cables 250 can be coupled to the PCB 210 using connectors 256. In other aspects, the coaxial cables 250 can be coupled to the PCB 210 using solder connections.

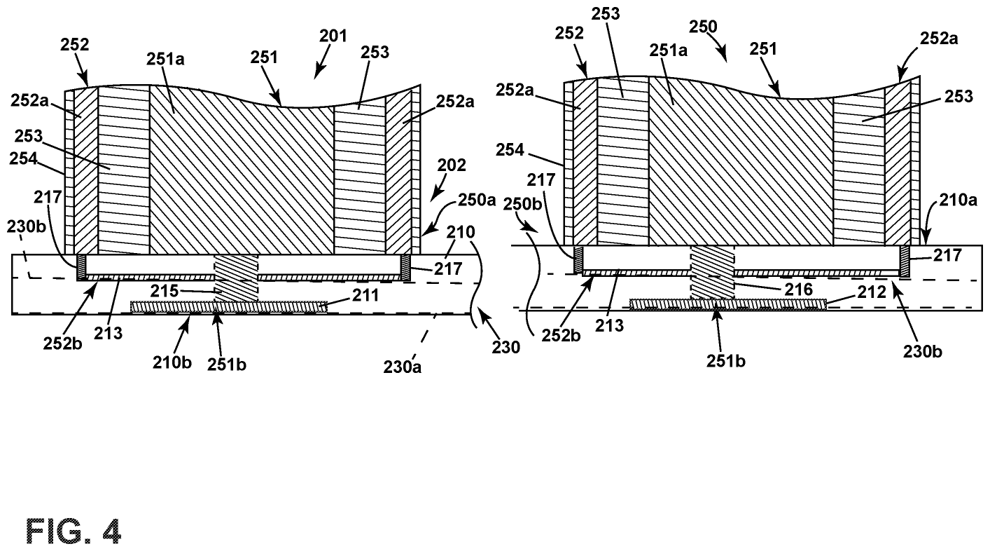

FIG. 4 depicts a block diagram of a cross-section of a portion of another non-limiting aspect of a transformer 300, with the ferromagnetic core 220 (shown in FIG. 3) omitted for clarity. The transformer 300 includes the primary winding 201 and the secondary winding 202 The primary winding 201 and the secondary winding 202 are each defined by respective coaxial cable portions (formed from the set of coaxial cables 250), and respective PCB portions (e.g., traces) formed on the PCB 210. For example, each coaxial cable 250 can include a respective first conductive element 251 (e.g., a copper wire), or primary conductor. Each coaxial cable 250 can be circumferentially surrounded by a first electrically insulative layer 253. The first electrically insulative layer 253 can be circumferentially surrounded by a generally tubular second conductive element 252. In some instances, the second conductive element 252 can be a sheath, shield, woven braid, or the like. In non-limiting aspects, a second electrically insulative layer 254 circumferentially surrounds the second conductive element 252. The first conductive element 251 and the second conductive element 252 extend from the first end 250a to the second end 250b of the coaxial cable 250.

The primary winding 201 can include a respective primary cable portion 251a and a respective primary PCB trace portion 251b. The secondary winding 202 can include a respective secondary cable portion 252a and a respective secondary PCB trace portion 252b. The first conductive element 251 of each coaxial cable 250 can form the respective primary cable portion 251a of the primary winding 201, and the second conductive element 252 of each coaxial cable 250 can form the respective secondary cable portion 252a of the secondary winding 202.

The PCB 210 can be a multi-layer PCB 210 and can include a set of layers 230. For example, in non-limiting aspects, the PCB 210 can include a first layer 230a, and a second layer 230b. The first layer 230a and the second layer 230b can be planar and formed of an insulative or dielectric material. The first layer 230a and the second layer 230b can be opposingly arranged (e.g., in parallel) between the first face 210a and the second face 210b. A first PCB trace 211 and a second PCB trace 212 can be disposed on the first layer 230a. The second PCB trace 212 is spaced from the first PCB trace 211 on the first layer 230a. A set of first vias 215 can be coupled to the first PCB trace 211. The set of first vias 215 can extend from the first PCB trace 211 to the first face 210a. A set of second vias 216 can be coupled to the second PCB trace 212. The set of second vias 216 can extend from the second PCB trace 212 to the first face 210a.

The respective first conductive element 251 of each coaxial cable 250 can be coupled to a respective first via 215 at the first end 250a and coupled to a respective second via 216 at the second end 250b. For example, in non-limiting aspects the respective primary cable portion 251a of each coaxial cable 250 can be coupled to the respective first via 215 and second via 216 via a solder connection (omitted for clarity). In some aspects, the respective primary cable portion 251a can be coupled to the respective first via 215 and second via 216 via a respective connector 256 (FIG. 3). The first PCB trace 211, the second PCB trace 212, the first vias 215 and the second vias 216 can cooperatively form the primary PCB trace portion 251b.

The second layer 230b can have a set of third PCB traces 213 disposed thereon. The set of third PCB traces 213 comprises a predetermined number (“N”) of the third PCB traces 213. The first PCB trace 211 and second PCB trace 212 can be opposingly spaced from a respective third PCB trace 213. Likewise, the first vias 215 and second vias 216 are spaced from the third PCB trace 213. A set of third vias 217 can be electrically coupled to the third PCB trace 213. In non-limiting aspects, the third vias 217 can extend to the first face 210a. The third PCB traces 213 and the third vias 217 can cooperatively form the secondary PCB trace portion 252b.

The respective secondary cable portion 252a of each coaxial cable 250 can be coupled to a respective third via 217 at the first end 250a and coupled to another respective third via 217 at the second end 250b. For example, in non-limiting aspects the respective secondary cable portion 252a of each coaxial cable 250 can be coupled to the respective third vias 217 via a solder connection. In some aspects, the respective secondary cable portion 252a can be coupled to the respective third vias 217 via a respective connector 256 (FIG. 3).

While FIG. 4 depicts the second layer 230b having the third PCB trace 213 disposed between the first layer 230a and the first face 210a, other aspects are not so limited. In other aspects, the first layer 230a can be disposed between the second layer 230b and the first face 210a without departing from the scope of the disclosure. Additionally, although not shown, it is contemplated that in non-limiting aspects, a subset of the third vias 217 can extend between the first face 210a and the second face 210b.

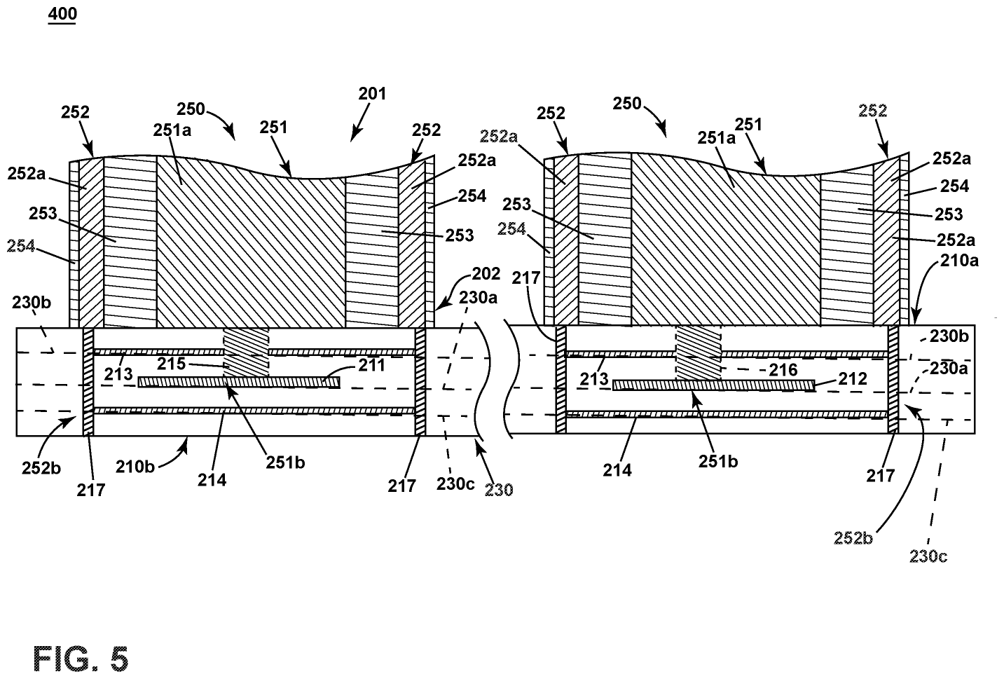

FIG. 5 is a block diagram of a cross-section of a portion of another exemplary aspect of the transformer 400 with the ferromagnetic core 220 omitted for clarity. The aspect depicted in FIG. 5 is similar to the aspect of FIG. 4, and like numbers refers to like parts. One notable difference between the aspect depicted in FIG. 4 and the aspect depicted in FIG. 5 is that the aspect of FIG. 5 includes a third layer 230c having a set of fourth PCB traces 214 disposed thereon.

In non-limiting aspects, the third layer 230c can be planar and formed of an insulative or dielectric material. The first layer 230a, the second layer 230b, and the third layer 230c are opposingly spaced from each other (e.g., in parallel) between the first face 210a and the second face 210b. In non-limiting aspects, the first layer 230a can be sandwiched or disposed between the second layer 230b and third layer 230c.

The first PCB trace 211 and the second PCB trace 212 are disposed on the first layer 230a, with the second PCB trace 212 spaced from the first PCB trace 211 on the first layer 230a. The first vias 215 and second vias 216 are spaced from the third PCB trace 213. The set of first vias 215 is coupled to the first PCB trace 211 and extends from the first PCB trace 211 to the first face 210a. The set of second vias 216 is coupled to the second PCB trace 212 and extends from the second PCB trace 212 to the first face 210a. The respective first conductive element 251 of each coaxial cable 250 can be coupled to the respective first via 215 at the first end 250a and coupled to the respective second via 216 at the second end 250b. For example, in non-limiting aspects the respective primary cable portion 251a of each coaxial cable 250 can be coupled to the respective first via 215 and second via 216 via a solder connection. In some aspects, the respective primary cable portion 251a can be coupled to the respective first via 215 and second via 216 via a connector (not shown).

The second layer 230b has the predetermined number (designated “N”) of third PCB traces 213 disposed thereon. Additionally, the third layer 230c can have the set of fourth PCB traces 214 disposed thereon. The set of fourth PCB traces 214 includes the predetermined number (“N”) of fourth PCB traces 214. Each fourth PCB trace 214 can be opposingly spaced from a respective third PCB trace 213. The first PCB trace 211 and second PCB trace 212 can be disposed between and opposingly spaced from a respective third PCB trace 213 and respective fourth PCB trace 214. The second conductive element 252 of each coaxial cable 250 can be coupled at the respective first end 250a and second end 250b to a respective third via 217. Each respective third via 217 can be coupled to a respective third PCB trace 213 and respective fourth PCB trace 214.

In non-limiting aspects, the set of third vias 217 can electrically couple the third PCB trace 213 and fourth PCB trace 214. At least a subset of the third vias 217 can extend to the first face 210a. In non-limiting aspects, another subset of the third vias 217 can extend between the first face 210a and the second face 210b. As such, at least a portion of the third PCB traces 213, fourth PCB traces 214, and set of third vias 217 is cooperatively arranged to circumferentially surround a portion of at least one of the first PCB trace 211 or the second PCB trace 212. The number of third vias 217 can be selected to surround a predetermined length of at least one of the first PCB trace 211 or the second PCB trace 212. The respective second conductive element 152 of each coaxial cable 250 is coupled to the third PCB trace 213 and fourth PCB trace 214 by the third vias 217. For example, the respective secondary cable portion 252a of each coaxial cable 250 can be coupled to at least one respective third via 217 at the first end 250a and coupled to another at least one respective third via 217 at the second end 250b. In non-limiting aspects the respective secondary cable portion 252a of each coaxial cable 250 can be coupled to the respective third vias 217 via a solder connection. In some aspects, the respective secondary cable portion 252a can be coupled to the respective third vias 217 via a connector (not shown). Accordingly, as illustrated in FIG. 5. the first conductive element 251 of the coaxial cable 250 is circumferentially surrounded by the second conductive element 252, and the first PCB trace 211 and second PCB trace 212 are likewise circumferentially surrounded by respective portions of the third PCB trace 213, fourth PCB trace 214, and the set of third vias 217. By arranging both the respective primary cable portion 251a of the primary winding 201 to be circumferentially surrounded by the secondary cable portion 252a, and further arranging the primary PCB trace portion 251b of the primary winding 201 to be circumferentially surrounded by the secondary PCB trace portion 252b of the secondary winding 202, a higher coupling coefficient over conventional transformers can be achieved.

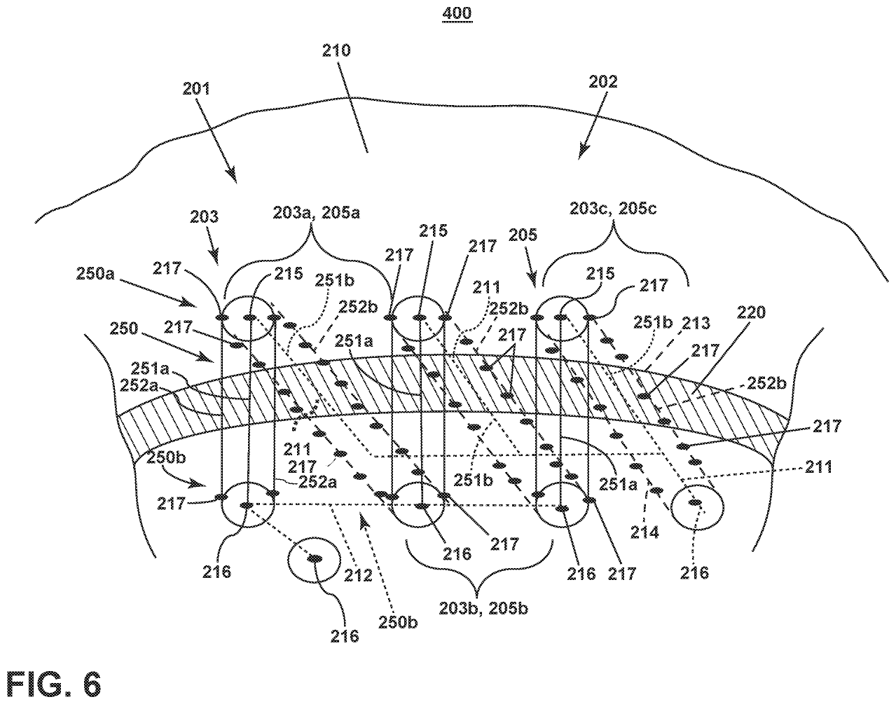

FIG. 6 is a schematic diagram of a portion of the PCB 210 of FIG. 5. One notable difference between FIG. 6 and FIG. 5 is that while FIG. 5 depicts the primary and secondary cable portions 251a, 252a and primary and secondary PCB trace portions 251b, 252b in two-dimensional format, FIG. 6 depicts the primary and secondary cable portions 251a, 252a in solid line schematic format, and the primary and secondary PCB trace portions 251b, 252b in dashed line format. Another notable difference is that FIG. 6 includes a portion of the ferromagnetic core 220 coupled to the first face 210a of the PCB 210, with the remaining portions of the ferromagnetic core 220 omitted for clarity.

As illustrated in the exemplary aspect of FIG. 6, the primary winding 201 includes a set of primary winding turns 203, designated as a first primary winding turn 203a, a second primary winding turn 203b, and a third primary winding turn 203c. In non-limiting aspects, the first, second, and third primary winding turns 203a, 203b, 203c can include a respective primary cable portion 251a (shown in solid line format) and a respective primary PCB trace portion 251b (shown in dashed line format). The respective primary PCB trace portion 251b can include portions of the first PCB trace 211, the second PCB trace 212, the set of first vias 215, the set of second vias 216 and combinations thereof. Each respective primary cable portion 251a can be coupled to a respective first via 215 at the first end 250a and coupled to a respective second via 216 at the second end 250b. In non-limiting aspects, and as illustrated in FIG. 6, the first primary winding turn 203a, the second primary winding turn 203b, and the third primary winding turn 203c can be electrically coupled in parallel with each other.

The secondary winding 202 includes a set of secondary winding turns 205 designated as a first secondary winding turn 205a, a second secondary winding turn 205b, and a third secondary winding turn 205c. In nonlimiting aspects, the first, second, and third secondary winding turns 205a, 205b, 205c can include a respective secondary cable portion 252a (shown in solid line format) and a respective secondary PCB trace portion 252b (shown in dashed line format). The respective secondary PCB trace portion 252b can include portions of the third PCB trace 213, the fourth PCB trace 214, the third vias 217, and combinations thereof. The set of third vias 217 can be arranged to extend from the first face 210a and coupled to the secondary PCB trace portion 252b such that portions of the first PCB trace 211 and second PCB trace 212 are circumferentially surrounded by respective portions of the third PCB trace 213, fourth PCB trace 214, and the set of third vias 217. Each respective secondary cable portion 252a can be coupled to a respective third via 217 at the first end 250a and coupled to another respective third via 217 at the second end 250b.

In non-limiting aspects, and as illustrated in FIG. 6, the first primary winding turn 203a, the second primary winding turn 203b, and the third primary winding turn 203c can be electrically coupled in parallel with each other. In non-limiting aspects, the first secondary winding turn 205a, the second secondary winding turn 205b, and the third secondary winding turn 205c can be electrically coupled in series with each other. In non-limiting aspects, the primary winding turns 203a, 203b, 203c coupled in parallel. When so arranged, with the primary winding turns (203a), (203b), (203c) electrically coupled in series, and the secondary winding turns (205a), (205b), (205c) electrically coupled in parallel, a transformer 200, 300, 400 having a turns ratio of 1:3 can be arranged.

While non-limiting aspects are shown and described for ease of description and understanding, as having three primary winding turns 203a, 203b, 203c, and three secondary winding turns 205a, 205b, 205c, other aspects are not so limited. Other non-limiting aspects can have any desired number of primary winding turns 203a, 203b, 203c, and desired number of secondary winding turns 205a, 205b, 205c, without departing from the scope of the disclosure. In this way, transformers 200, 300, 400 having any desired turn ratios can be arranged. For example, the predetermined number N of third PCB traces 213 and fourth PCB traces 214 can be determined based on a desired turn ratio of the transformer 200, 300, 400. In non-limiting aspects, for a particular transformer 200, 300, 400 having a turn ratio of 1:T, the predetermined number N of third PCB traces 213 can be equal to T. For example, for a particular transformer having a turn ratio of 1:3, the number N of third PCB traces 213 and the number N of fourth PCB traces 214 can be equal to 3. In some non-limiting aspects, the primary winding turns 203a, 203b, 203c and secondary winding turns 205a, 205b, 205c can be arranged to define a turn ratio of 1:T, wherein a number N of first PCB traces 211 and the number of second PCB traces 212 are equal to T. Conversely, in other non-limiting aspects, the primary winding turns 203a, 203b, 203c and secondary winding turns 205a, 205b, 205c are arranged to define a turn ratio of T:1, wherein the number N of first PCB traces 211 and the number N of second PCB traces 212 are equal to T.

Additionally, while non-limiting aspects are shown and described for ease of description and understanding, with the primary winding turns 203a, 203b, 203c, coupled in parallel and the secondary winding turns 205a, 205b, 205c coupled in series, other aspects are not so limited. In other non-limiting aspects, the primary winding turns 203a, 203b, 203c, can be coupled in series or in parallel. In still other non-limiting aspects, the secondary winding turns 205a, 205b, 205c can be coupled in series or in parallel.

It will be appreciated that since the respective primary cable portion 251a of the first, second, and third primary winding turns 203a, 203b, 203c includes the first conductive element 251 (FIG. 5) of a respective coaxial cable 250, and the respective secondary cable portion 252a of the first, second, and third secondary winding turns 205a, 205b, 205c includes the second conductive element 252 (FIG. 5) of the respective coaxial cable 250, the respective secondary cable portion 252a of the first, second, and third secondary winding turns 205a, 205b, 205c circumferentially surrounds the respective primary cable portion of 251a of the first, second, and third primary winding turns 203a, 203b, 203c.

Each of the first, second, and third primary winding turns 203a, 203b, 203c can be cooperatively defined by a respective portion of the first PCB trace 211, a respective portion of the second PCB trace 212 and a respective first conductive element 251 of at least one coaxial cable 250. The first primary winding turn 203a, the second primary winding turn 203b, and the third primary winding turn 203c each include a respective primary cable portion 251a and a respective primary PCB trace portion 251b. The first secondary winding turn 205a, second secondary winding turn 205b, and the third secondary winding turn 205c each include a respective secondary cable portion 252a and a secondary PCB trace portion 252b.

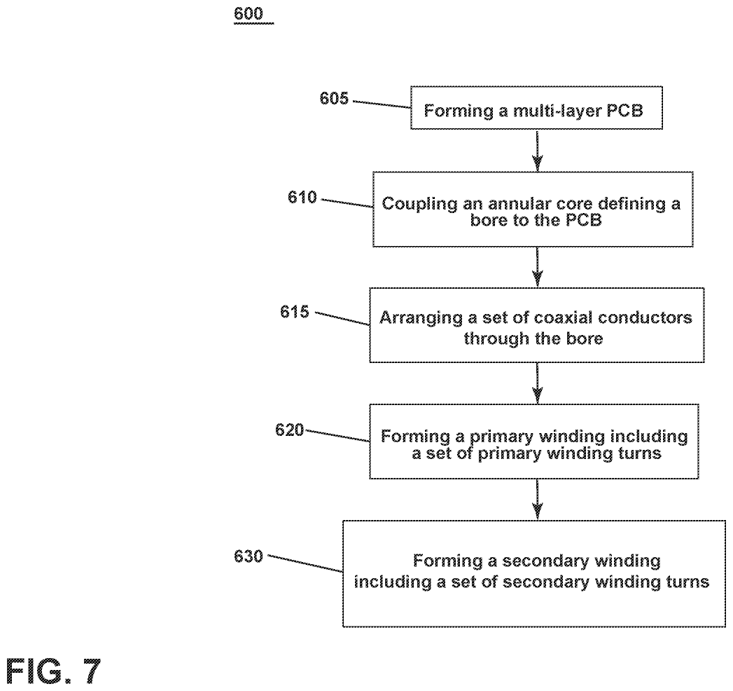

FIG. 7 depicts a method 600 of forming a transformer 200, 300, 400. Although described in terms of a transformer, it will be appreciated that the method 600 can be applied to other devices including inductors and coupled inductors. While the method 600 is described herein, for ease of understanding, in terms of the transformer 200, 300, 400 of FIGS. 2-6, other aspects are not so limited and the method 600 can be implemented with any transformer without departing from the scope of the disclosure.

The transformer 200, 300, 400 can include the primary winding 201 and the secondary winding 202. The primary winding 201 can include the respective primary cable portion 251a and the respective primary PCB trace portion 251b. The secondary winding 202 can include a respective secondary cable portion 252a and the respective secondary PCB trace portion 252b. The first conductive element 251 of each coaxial cable 250 can form the respective primary cable portion 251a of the primary winding 201, and the second conductive element 252 of each coaxial cable 250 can form the respective secondary cable portion 252a of the secondary winding 202.

The method 600 can begin at 605 by forming the multi-layer PCB 210. The multi-layer PCB 210 can include the first face 210a opposingly spaced from the second face 210b. The PCB 210 can include the set of layers 230. For example, in non-limiting aspects, the PCB 210 can include the first layer 230a, and the second a second layer 230b. The first layer 230a and the second layer 230b can be planar and formed of an insulative or dielectric material. The first layer 230a and the second layer 230b can be opposingly arranged (e.g., in parallel) between the first face 210a and the second face 210b. The first PCB trace 211 and the second PCB trace 212 can be disposed on the first layer 230a. The second PCB trace 212 is spaced from the first PCB trace 211 on the first layer 230a. The set of first vias 215 can be coupled to the first PCB trace 211. The set of first vias 215 can extend from the first PCB trace 211 to the first face 210a. The set of second vias 216 can be coupled to the second PCB trace 212. The set of second vias 216 can extend from the second PCB trace 212 to the first face 210a.

The respective first conductive element 251 of each coaxial cable 250 can be coupled to the respective first via 215 at the first end 250a and coupled to the respective second via 216 at the second end 250b. The first PCB trace 211, the second PCB trace 212, the first vias 215 and the second vias 216 can cooperatively form the primary PCB trace portion 251b.

In non-limiting aspects, the second layer 230b can have a set of third PCB traces 213 disposed thereon. The set of third PCB traces 213 can include the predetermined number “N” of third PCB traces 213. The first PCB trace 211 and second PCB trace 212 can be opposingly spaced from a respective third PCB trace 213. The set of third vias 217 can be electrically coupled to the third PCB trace 213. In non-limiting aspects, the third vias 217 can extend to the first face 210a. In non-limiting aspects, a subset of the third vias 217 can extend between the first face 210a and the second face 210b. The third PCB traces 213 and the third vias 217 can cooperatively form the secondary PCB trace portion 252b.

In non-limiting aspects, the first via 215 can extend from the first face 210a to the first PCB trace 211 and coupled thereto, the second via 216 extending from the first face 210a to the second PCB trace 212 and electrically coupled thereto, a second layer 230b having a number N of third PCB traces 213 defined thereon, the first PCB trace 211 and second PCB trace 212 opposingly spaced from the third PCB traces 213, and the set of conductive third vias 217 extending from the first face 210a to the third PCB trace 213 and electrically coupled thereto.

The method can include at 610 coupling the annular ferromagnetic core 220 defining a bore 225 to the first face 210a. In non-limiting aspects, the ferromagnetic core 220 can be coupled to the first face 210a using straps 222. In other non-limiting aspects, the ferromagnetic core 220 can be coupled to the first face 210a using clamps, fasteners, adhesives, or combinations thereof. The method 600 can include, at 615, arranging a set of coaxial cables 250 longitudinally through the bore 225. In non-limiting aspects, each coaxial cable 250 can include a first conductive element 251 circumferentially surrounded by, and electrically insulated from, the second conductive element 252, and respectively defining a first end 250a and an opposing second end 250b.

The method can include at 620, forming the primary winding 201 including a set of primary winding turns 203. In non-limiting aspects, each primary winding turn 203 can include a respective first conductive element 251 of at least one coaxial cable 250, a portion of a respective first PCB trace 211, and a respective portion of the second PCB trace 212, the respective first conductive element 251 coupled to the first PCB trace 211 by a respective first via 215 at the respective first end 250a, and coupled to the respective portion of the second PCB trace 212 by a respective second via 216 at the respective second end 250b.

The method can include, at 630, forming a secondary winding 202 including a set of secondary winding turns 205. In non-limiting aspects, each secondary winding turn 205 can comprise a respective second conductive element 252 of at least one coaxial cable 250 of the set of coaxial conductors 250, and a portion of a respective third PCB trace 213. The respective second conductive element 252 can be coupled to the respective portion of the third PCB trace 213 by a respective third via 217 at the respective first end 250a and further coupled to the third PCB trace 213 by another respective third via 217 at the respective second end 250b.

In non-limiting aspects of the method 600, the forming the primary winding 201 can include electrically coupling the primary winding turns 203 in parallel with respect to each other. In other non-limiting aspects, the forming the primary winding 201 can include electrically coupling the primary winding turns 203 in series with respect to each other.

In non-limiting aspects of the method 600, the forming a secondary winding 202 can include electrically coupling the secondary winding turns 205 in parallel with respect to each other. In other non-limiting aspects, the forming a secondary winding 202 can include electrically coupling the secondary winding turns 205 in series with respect to each other.

In non-limiting aspects of the method 600, the forming the primary winding 201 at 620, and the forming the secondary winding 202 at 630, can include arranging the primary winding turns 203 and secondary winding turns 205 to define a turn ratio of 1:T. In non-limiting aspects, the number N of third PCB traces 213 can be equal to T. In other non-limiting aspects, the forming the primary winding 201 at 620, and the forming the secondary winding 202 at 630, can include arranging the primary winding turns 203 and secondary winding turns 205 to define a turn ratio of T:1. In non-limiting aspects, the number N of third PCB traces 213 is equal to T.

In still other non-limiting aspects, the forming the primary winding 201 at 620, and the forming the secondary winding 202 at 630, can include arranging the primary winding turns 203 and secondary winding turns 205 to define a turn ratio of 1:T, wherein the set of primary winding turns 203 and the set of secondary winding turns 205 each comprise a number T of turns. In some non-limiting aspects, the primary winding turns 203a, 203b, 203c and secondary winding turns 205a, 205b, 205c can be arranged to define a turn ratio of 1:T, wherein a number N of first PCB traces 211 and the number of second PCB traces 212 are equal to T. Conversely, in other non-limiting aspects, three primary winding turns 203a, 203b, 203c and secondary winding turns 205a, 205b, 205c are arranged to define a turn ratio of T:1, wherein the number N of first PCB traces 211 and the number N of second PCB traces 212 are equal to T.

In non-limiting aspects, the set of layers 230 can include a dielectric third layer 230c layer having the number N of fourth PCB traces 214 defined thereon, each fourth PCB trace 214 opposing at least a portion of at least one of the first PCB trace 211 and the second PCB trace 212. In such non-limiting aspects, the first PCB trace 211 and second PCB trace 212 can be disposed between and opposingly spaced from the third PCB traces 213 and the fourth PCB traces 214. In some aspects, the set of conductive third vias 217 extending from the first face 210a to the third PCB trace 213 can further extend to a respective one of the set of fourth PCB traces 214, and electrically couple each fourth PCB trace 214 with a respective one of the third PCB trace 213.

In non-limiting aspects of the method 600, a portion of a respective third PCB trace 213, a portion of a respective fourth PCB trace 214, and a respective subset of the third vias 217 cooperatively circumferentially surround at least a portion of one of the first PCB trace 211 and second PCB trace 212.

In non-limiting aspects, the forming the primary winding 201 at 620, and the forming the secondary winding 202 at 630, can include arranging the primary winding turns 203 and secondary winding turns 205 to define a turn ratio of 1:T. In such non-limiting aspects, the number N of third PCB traces 213 can be equal to T, and the number N of fourth PCB traces 214 can be equal to T.

In non-limiting aspects of the method 600, each primary winding turn 203 can be circumferentially surrounded by a portion of a secondary winding turn 205.

While the present disclosure has been described with reference to one or more exemplary aspects, it will be understood by those skilled in the art that various changes can be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure is not limited to the particular aspect(s) disclosed as the best mode contemplated for carrying out this disclosure, but that the disclosure will include the aspects falling within the scope of the appended claims.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the disclosure are provided by the subject matter of the following clauses:

A transformer comprising: a multi-layer printed circuit board (PCB) having a first face and an opposing second face, and a set of dielectric layers disposed between the first face and second face, the set of dielectric layers including a first layer having a first PCB trace and a second PCB trace defined thereon, and a second layer having a set of third PCB traces defined thereon, the first PCB trace and the second PCB trace opposingly spaced from the third PCB traces extending from the first face to the third PCB trace and electrically coupled thereto;
a set of first vias extending from the first face to the first PCB trace and coupled to the first PCB trace; a set of second vias extending from the first face to the second PCB trace and electrically coupled second PCB trace; an annular magnetic core defining a bore coupled to the first face; a set of coaxial conductors longitudinally extending through the bore, each coaxial conductor having a first conductive element circumferentially surrounded by, and electrically insulated from, a second conductive element, and respectively defining a first end and an opposing second end; a primary winding including a set of primary winding turns, each primary winding turn comprising a respective first conductive element of at least one coaxial conductor, a respective portion of the first PCB trace, and a respective portion of the second PCB trace, the respective first conductive element being coupled to the respective portion of the first PCB trace by a respective first via at the respective first end, and coupled to the respective portion of the second PCB trace by a respective second via at a respective second end; a secondary winding including a set of secondary winding turns, each secondary winding turn comprising a respective second conductive element of each coaxial conductor; and a set of third vias extending from the first face to the third PCB traces and coupled to the third PCB traces; wherein a respective portion of a third PCB trace, the respective outer second conductive element are coupled to the respective portion of the third PCB trace by a respective third via at the respective first end and further coupled to the third PCB trace by another respective third via at the respective second end.

The transformer of any preceding clause, wherein each one of the set of primary winding turns are electrically coupled in parallel with respect to each other, and each one of the set of secondary winding turns are electrically coupled in series with each other.

The transformer of any preceding clause, wherein each one of the set of primary winding turns are electrically coupled in series with respect to each other, and each one of the set of secondary winding turns are electrically coupled in parallel with each other.

The transformer of any preceding clause, wherein each one of the set of primary winding turns and the set of secondary winding turns are arranged to define a turn ratio of 1:T, and wherein the set of third PCB traces includes a number N of third PCB traces, wherein the number N is equal to T.

The transformer of any preceding clause, wherein the set of primary winding turns and the set of secondary winding turns are arranged to define a turn ratio of T:1, and wherein the set of third PCB traces includes a number N of third PCB traces, wherein the number N is equal to T.

The transformer of any preceding clause, wherein the set of primary winding turns and the set of secondary winding turns are arranged to define a turn ratio of 1:1.

The transformer of any preceding clause, wherein the set of dielectric layers further includes a third layer having a set of fourth PCB traces defined thereon, each fourth PCB trace opposing at least a portion of at least one of the first PCB trace and the second PCB trace, wherein the first PCB trace and the second PCB trace are disposed between and opposingly spaced from respective portions of the third PCB traces and the fourth PCB traces, and wherein the set of third vias extending from the first face to the third PCB trace further extend to a respective one of the fourth PCB traces, and electrically couple each fourth PCB trace (214) with a respective one of the third PCB traces.

The transformer of any preceding clause, wherein a portion of a respective third PCB trace, a portion of a respective fourth PCB trace, and a respective subset of the set of third vias cooperatively circumferentially surround at least a portion of one of the first PCB trace and the second PCB trace.

The transformer of any preceding clause, wherein the set of primary winding turns and the set of secondary winding turns are arranged to define a turn ratio of 1:T, and wherein the set of third PCB traces include a number N of third PCB traces, and the set of fourth PCB traces include the number N of fourth PCB traces, wherein the number N is equal to T.

The transformer of any preceding clause, wherein each primary winding turn is circumferentially surrounded by a portion of a respective secondary winding turn.

A method of forming a transformer, comprising: forming a multi-layer printed circuit board having a first face and an opposing second face, and a set of dielectric layers disposed between the first face and second face, the set of dielectric layers including a first layer having a first PCB trace and a second PCB trace defined thereon, a first via extending from the first face to the first PCB trace and coupled to the first PCB trace, a second via extending from the first face to the second PCB trace and electrically coupled to the second PCB trace, a second layer having a set of third PCB traces defined thereon, the first PCB trace and the second PCB trace opposingly spaced from the third PCB traces, and a set of third vias extending from the first face to the third PCB traces and electrically coupled to the third PCB traces; coupling an annular magnetic core defining a bore to the first face; arranging a set of coaxial conductors longitudinally through the bore, each coaxial conductor including a first conductive element circumferentially surrounded by, and electrically insulated from, a second conductive element, and respectively defining a first end and a second end; forming a primary winding including a set of primary winding turns, each primary turn comprising a respective first conductive element of at least one coaxial conductor of the set of coaxial conductors, a portion of a respective first PCB trace, and a respective portion of the second PCB trace, the respective first conductive element coupled to the respective portion of the first PCB trace by a respective first via at the respective first end, and coupled to the respective portion of the second PCB trace by a respective second via at the respective second end; and forming a secondary winding including a set of secondary winding turns, each secondary turn comprising a respective second conductive element of at least one coaxial conductor of the set of coaxial conductors, and a portion of a respective third PCB trace, the respective second conductive element coupled to the respective portion of the third PCB trace by a respective third via at the respective first end and further coupled to the third PCB trace by another respective third via at the respective second end.

The method of claim 11, further comprising electrically coupling the set of primary winding turns in parallel with respect to each other, and electrically coupling the set of secondary winding turns in series with each other.

The method of any preceding clause, further comprising electrically coupling the set of primary winding turns in series with respect to each other, and electrically coupling the set of secondary winding turns in parallel with each other.

The method of any preceding clause, wherein the set of primary winding turns and the set of secondary winding turns are arranged to define a turn ratio of 1:T, and wherein the set of third PCB traces includes a number N of third PCB traces, wherein the number N is equal to T.

The method of any preceding clause, wherein the set of primary winding turns and the set of secondary winding turns are arranged to define a turn ratio of T:1, and wherein the set of third PCB traces includes a number N of third PCB traces, wherein the number N is equal to T.

The method of any preceding clause, wherein the set of primary winding turns and the set of secondary winding turns are arranged to define a turn ratio of 1:1.

The method of any preceding clause, wherein the set of dielectric layers further includes a third layer having a set of fourth PCB traces defined thereon, each fourth PCB trace opposing at least a portion of at least one of the first PCB trace and the second PCB trace, wherein the first PCB trace and the second PCB trace are disposed between and opposingly spaced from the third PCB traces and the fourth PCB traces, and wherein the set of third vias extending from the first face to the third PCB trace further extend to a respective one of the fourth PCB traces, and electrically couple each fourth PCB trace with a respective third PCB trace.

The method of any preceding clause, wherein a portion of a respective third PCB trace, a portion of a respective fourth PCB trace, and a respective subset of the set of third vias cooperatively circumferentially surround at least a portion of one of the first PCB trace and the second PCB trace.

The method of any preceding clause, wherein the set of primary winding turns and the set of secondary winding turns are arranged to define a turn ratio of 1:T, and wherein the set of third PCB traces includes a number N of third PCB traces, the set of fourth PCB traces includes the number N of fourth PCB traces, wherein the number N is equal to T.

The method of any preceding clause, wherein each primary winding turn is circumferentially surrounded by a portion of a secondary winding turn.

What is claimed is:

1. A transformer comprising:
a multi-layer printed circuit board (PCB) having a first face and an opposing second face, and a set of dielectric layers disposed between the first face and second face, the set of dielectric layers including a first layer having a first PCB trace and a second PCB trace defined thereon, and a second layer having a set of third PCB traces defined thereon, the first PCB trace and the second PCB trace opposingly spaced from the third PCB traces extending from the first face to the third PCB trace and electrically coupled thereto;
a set of first vias extending from the first face to the first PCB trace and coupled to the first PCB trace;
a set of second vias extending from the first face to the second PCB trace and electrically coupled second PCB trace;
an annular magnetic core defining a bore coupled to the first face;
a set of coaxial conductors longitudinally extending through the bore, each coaxial conductor having a first conductive element circumferentially surrounded by, and electrically insulated from, a second conductive element, and respectively defining a first end and an opposing second end;
a primary winding including a set of primary winding turns, each primary winding turn comprising a respective first conductive element of at least one coaxial conductor, a respective portion of the first PCB trace, and a respective portion of the second PCB trace, the respective first conductive element being coupled to the respective portion of the first PCB trace by a respective first via at the respective first end, and coupled to the respective portion of the second PCB trace by a respective second via at a respective second end;
a secondary winding including a set of secondary winding turns, each secondary winding turn comprising a respective second conductive element of each coaxial conductor; and
a set of third vias extending from the first face to the third PCB traces and coupled to the third PCB traces;
wherein a respective portion of a third PCB trace, the respective outer second conductive element are coupled to the respective portion of the third PCB trace by a respective third via at the respective first end and further coupled to the third PCB trace by another respective third via at the respective second end.

2. The transformer of claim 1, wherein each one of the set of primary winding turns are electrically coupled in parallel with respect to each other, and each one of the set of secondary winding turns are electrically coupled in series with each other.

3. The transformer of claim 1, wherein each one of the set of primary winding turns are electrically coupled in series with respect to each other, and each one of the set of secondary winding turns are electrically coupled in parallel with each other.

4. The transformer of claim 1, wherein each one of the set of primary winding turns and the set of secondary winding turns are arranged to define a turn ratio of 1:T, and wherein the set of third PCB traces includes a number N of third PCB traces, wherein the number N is equal to T.

5. The transformer of claim 1, wherein the set of primary winding turns and the set of secondary winding turns are arranged to define a turn ratio of T:1, and wherein the set of third PCB traces includes a number N of third PCB traces, wherein the number N is equal to T.

6. The transformer of claim 1, wherein the set of primary winding turns and the set of secondary winding turns are arranged to define a turn ratio of 1:1.

7. The transformer of claim 1, wherein the set of dielectric layers further includes a third layer having a set of fourth PCB traces defined thereon, each fourth PCB trace opposing at least a portion of at least one of the first PCB trace and the second PCB trace,
wherein the first PCB trace and the second PCB trace are disposed between and opposingly spaced from respective portions of the third PCB traces and the fourth PCB traces, and
wherein the set of third vias extending from the first face to the third PCB trace further extend to a respective one of the fourth PCB traces, and electrically couple each fourth PCB trace (214) with a respective one of the third PCB traces.

8. The transformer of claim 7, wherein a portion of a respective third PCB trace, a portion of a respective fourth PCB trace, and a respective subset of the set of third vias cooperatively circumferentially surround at least a portion of one of the first PCB trace and the second PCB trace.

9. The transformer of claim 7, wherein the set of primary winding turns and the set of secondary winding turns are arranged to define a turn ratio of 1:T, and wherein the set of third PCB traces include a number N of third PCB traces, and the set of fourth PCB traces include the number N of fourth PCB traces, wherein the number N is equal to T.

10. The transformer of claim 7, wherein each primary winding turn is circumferentially surrounded by a portion of a respective secondary winding turn.

11. A method of forming a transformer, comprising:
forming a multi-layer printed circuit board having a first face and an opposing second face, and a set of dielectric layers disposed between the first face and second face, the set of dielectric layers including a first layer having a first PCB trace and a second PCB trace defined thereon, a first via extending from the first face to the first PCB trace and coupled to the first PCB trace, a second via extending from the first face to the second PCB trace and electrically coupled to the second PCB trace, a second layer having a set of third PCB traces defined thereon, the first PCB trace and the second PCB trace opposingly spaced from the third PCB traces, and a set of third vias extending from the first face to the third PCB traces and electrically coupled to the third PCB traces;
coupling an annular magnetic core defining a bore to the first face;
arranging a set of coaxial conductors longitudinally through the bore, each coaxial conductor including a first conductive element circumferentially surrounded by, and electrically insulated from, a second conductive element, and respectively defining a first end and a second end;
forming a primary winding including a set of primary winding turns, each primary turn comprising a respective first conductive element of at least one coaxial conductor of the set of coaxial conductors, a portion of a respective first PCB trace, and a respective portion of the second PCB trace, the respective first conductive element coupled to the respective portion of the first PCB trace by a respective first via at the respective first end, and coupled to the respective portion of the second PCB trace by a respective second via at the respective second end; and
forming a secondary winding including a set of secondary winding turns, each secondary turn comprising a respective second conductive element of at least one coaxial conductor of the set of coaxial conductors, and a portion of a respective third PCB trace, the respective second conductive element coupled to the respective portion of the third PCB trace by a respective third via at the respective first end and further coupled to the third PCB trace by another respective third via at the respective second end.

12. The method of claim 11, further comprising electrically coupling the set of primary winding turns in parallel with respect to each other, and electrically coupling the set of secondary winding turns in series with each other.

13. The method of claim 11, further comprising electrically coupling the set of primary winding turns in series with respect to each other, and electrically coupling the set of secondary winding turns in parallel with each other.

14. The method of claim 11, wherein the set of primary winding turns and the set of secondary winding turns are arranged to define a turn ratio of 1:T, and wherein the set of third PCB traces includes a number N of third PCB traces, wherein the number N is equal to T.

15. The method of claim 11, wherein the set of primary winding turns and the set of secondary winding turns are arranged to define a turn ratio of T:1, and wherein the set of third PCB traces includes a number N of third PCB traces, wherein the number N is equal to T.

16. The method of claim 11, wherein the set of primary winding turns and the set of secondary winding turns are arranged to define a turn ratio of 1:1.

17. The method of claim 11, wherein the set of dielectric layers further includes a third layer having a set of fourth PCB traces defined thereon, each fourth PCB trace opposing at least a portion of at least one of the first PCB trace and the second PCB trace,
wherein the first PCB trace and the second PCB trace are disposed between and opposingly spaced from the third PCB traces and the fourth PCB traces, and
wherein the set of third vias extending from the first face to the third PCB trace further extend to a respective one of the fourth PCB traces, and electrically couple each fourth PCB trace with a respective third PCB trace.

18. The method of claim 17, wherein a portion of a respective third PCB trace, a portion of a respective fourth PCB trace, and a respective subset of the set of third vias cooperatively circumferentially surround at least a portion of one of the first PCB trace and the second PCB trace.

19. The method of claim 17, wherein the set of primary winding turns and the set of secondary winding turns are arranged to define a turn ratio of 1:T, and wherein the set of third PCB traces includes a number N of third PCB traces, the set of fourth PCB traces includes the number N of fourth PCB traces, wherein the number N is equal to T.

20. The method of claim 17, wherein each primary winding turn is circumferentially surrounded by a portion of a secondary winding turn.
